(19) United States
(12) Patent Application Publication
(10) Pub. No.: US 2025/0229342 A1
(43) Pub. Date: Jul. 17, 2025

(54) Drill, and method for producing a drill

(71) Applicant: Kennametal Inc., Latrobe, PA (US)

(72) Inventors: Christian Strauchmann, Eggolsheim (DE); Herbert Rudolf Kauper, Rosstal (DE); Jürgen Schwägerl, Vohenstrauss (DE); Peter Sollfrank, Waldthurn (DE)

(21) Appl. No.: 19/013,643

(22) Filed: Jan. 8, 2025

(30) Foreign Application Priority Data
Jan. 12, 2024 (DE) 1020242003042

(51) Int. Cl. B23B 51/02

(52) U.S. Cl. CPC B23B 51/02

(57) ABSTRACT

The drill extends along an axis of rotation and comprises at least three main cutting surfaces which, starting from a cutting corner arranged on a radius (r), each extend in the direction of the axis of rotation. The at least three main cutting surfaces converge on a pointed drill tip, in particular without the presence of transverse cutting surfaces. Starting from the drill tip and over the entire radial extent thereof, each main cutting surface adjoins an edge-free surface, which comprises a clearance surface and in each case transitions into a respective flute.

### RELATED APPLICATION DATA

The present application claims priority pursuant to 35 U.S.C. § 119(a) to German Patent Application Number 1020242003042 filed Jan. 12, 2024, which is incorporated herein by reference in its entirety.

### FIELD

The invention relates to a drill and a method for producing a drill.

### BACKGROUND

The geometry and design of a drill tip is generally essential in a drill. In this context, the interaction of cutting surfaces, clearance surfaces, and flutes is important.

Typical drills comprise two main cutting surfaces and a flute associated with each of them. The flute often extends in a spiraling manner along a shaft of the drill. In addition to integral solid carbide drills, modular drill tools are also known in which a reversibly exchangeable drill head can be attached to a shaft.

A drill having two main cutting surfaces which are connected to one another in a drill center via a transverse cutting surface can be gathered from EP 1 230 058 B1. The clearance surfaces are each designed as a curved surface of the respective main cutting surface which is designed to be edge-free in the direction of the flute.

A drill comprising three main cutting surfaces, which are interconnected via transverse cutting surfaces and which have a complex cutting geometry overall can be gathered from US 2011/0085868 A1.

In drills, there is often the problem of maximizing positional accuracy at the start of the drilling operation. Particularly in the case of smooth surfaces or surfaces oriented obliquely to a longitudinal axis of the drill, there is often the problem that the drill will be offset somewhat laterally with respect to a desired target position. In addition, the front faces of drills are subjected to a high mechanical frictional load, especially given hard materials, which can lead to a high level of wear. The additional problem in the case of carbide drills is that, although they do feature a high level of hardness, they also feature a high level of brittleness, so point-like loads may lead to scoring activity, which may lead to chipping of the drill material.

### SUMMARY

Based on this, the object of the invention is to specify a drill as well as a method for the manufacture thereof, whereby the drill is characterized by a high level of positional accuracy and low wear.

The object according to the invention is achieved by a drill, which extends along an axis of rotation and has at least three, preferably exactly three, main cutting surfaces. Starting from a cutting corner arranged on a radius, these cutting surfaces each extend in the direction of the axis of rotation. The at least three main cutting surfaces converge on a drill tip. In addition, starting from the drill tip and along the radial extent of the respective main cutting surface, a respective main cutting surface adjoins an edge-free surface in the circumferential direction. This edge-free surface also comprises at least a portion of a clearance surface, which portion in each case transitions into a respective flute.

It should first be emphasized that a respective main cutting surface extends as far as the drill tip, thus extending as far as the axis of rotation. The drill tip is arranged on the axis of rotation. The main cutting surfaces converge at a common point. The drill tip is therefore pointed. A high level of initial positioning accuracy is achieved by the pointed drill tip because there is little risk of lateral displacement, or only a minimal risk thereof at the beginning of the drilling operation. In contrast, conventional drills comprising transverse cutting surfaces present this problem.

In the present context—within the scope of manufacturing tolerances—a “pointed” surface is understood to mean one with a diameter of less than 100 μm and in particular less than 20 μm. The drill tip is therefore formed within the manufacturing tolerances by a location where the main cutting surfaces meet.

It should in particular be emphasized that the main cutting surface-starting from the drill tip and as far as the cutting corner-adjoins an edge-free surface in the circumferential direction, which edge-free surface at least partially, and preferably completely, forms the clearance surface extending as far as the flute. The term “clearance surface” is generally understood to mean a surface which adjoins a respective main cutting surface, is inclined with respect to a horizontal plane (the plane perpendicular to the axis of rotation), and which extends as far as the respective flute. The clearance surface forms a clearance angle with respect to such a horizontal plane and is conventionally in the range of several degrees.

It should also be emphasized that this clearance surface, which adjoins the respective main cutting surface in an edge-free manner, extends as far as the pointed drill tip. In the case of conventional drills, at least one transverse cutting surface and, in addition, what is referred to as a “point” is typically introduced in the center region and is formed by means of separate grinding. A step, and thus an edge, in the direction of the clearance surface is generated by means of the separate grinding step. By then providing an edge-free design for each of the surfaces adjoining the respective main cutting surfaces, wear is minimized due to the absence of edges. This design is also particularly suitable for carbide drills because the absence of an edge in the highly stressed front-end region of the drill avoids point or line loading, which may lead to high scoring activity and material chipping thereby.

Said object is also achieved by a method for producing such a drill, whereby the edge-free surfaces are formed using a grinding method, and whereby only one respective grinding step is provided for each edge-free surface. The entire edge-free surface is therefore only achieved in a single, continuous grinding step without multiple attachments of the grinding disk. The complete surface, which adjoins a respective transverse cutting surface and extends in the circumferential direction as far as the flute, thus also comprising the complete clearance surface, is preferably only ground in a single grinding step. The grinding disk and the drill are moved in a suitable manner in a three-dimensional motion sequence, continuously and without removal relative to one another. As a result of the continuous movement, the grinding disk is therefore continuously moved relative to the drill along a specified trajectory. Given that this relative motion is not stopped or interrupted, edge formation is reliably avoided.

Therefore, the term “edge-free” is in particular understood to mean a progression of the surface in which no sharp edges are formed between adjoining surface sections. The term “sharp edges” also refers to transitions between contiguous surface sections with a radius of up to a maximum of 3% of the drill diameter and preferably up to a maximum of 1% of the drill diameter mm.

Further advantageously, the drill therefore comprises no transverse cutting surfaces, i.e., it is designed without transverse cutting surfaces. The particular advantage achieved thereby is that each radial section of the drill contributes to cutting, and—as is the case with conventional designs comprising transverse cutting surfaces—no cutting action is achieved in the region of the transverse cutting surfaces. The lack of transverse cutting surfaces in particular also supports the high level of positioning accuracy.

The term “transverse cutting surface” is generally understood to mean a cutting region which is located between the axis of rotation and the start of a point.

In the preferred embodiment, a tip region of the drill is only formed by edge-free surfaces adjoining the respective main cutting surface. Therefore, in a drill comprising three cutting surfaces, the tip region is only formed by the three main cutting surfaces, the pointed drill bit, and the three edge-free surfaces. In this context, the tip region is defined as the frontmost axial region of the drill extending from the drill bit to an axial length corresponding to at least ¼ of the radius, in particular at least ⅓ of the radius, and preferably at least half of the radius. As a result, starting from the drill tip and least as far as the axial length defined thereby, no edges are therefore present on the surfaces adjoining the main cutting surfaces.

The tip region, and thus the axial length thereof starting from the drill tip, preferably terminates at an axial length with a first full bit diameter, i.e., at an axial position of the drill where a drill bit is not tapered by means of grinding or other measures in the region of the front face at the end of the drill. The bit diameter is normally defined by the remaining circular diameter of the drill at a specified flute depth in the region of the flutes. The bit diameter is therefore generally defined by a nominal radius of the drill minus the flute depth. In particular, this axial length therefore also defines the axial position where the clearance surface transitions into the respective flute, thus where the flute begins. This transition into the flute is optionally achieved via a rounding or an edge.

In the preferred embodiment, exactly three main cutting surfaces are formed, and the three edge-clearance surfaces are in particular formed in the manner of tetrahedron surfaces of a degenerated tetrahedron which is twisted around the axis of rotation. In the present context, the term “degenerated tetrahedron” is understood to mean a three-dimensional structure which is conceptually formed by the three edge-free surfaces initially forming surfaces of a tetrahedron which extends from a tetrahedron tip to a base, and the base of this tetrahedron is twisted about the axis of rotation, while the tetrahedron tip is simultaneously fixed. This degenerated tetrahedron formed thereby forms the previously defined tip region in particular.

In the advantageous embodiment, the respective main cutting surface-when seen from above-extends in a curved and, in particular, convexly curved manner into the drill tip. Therefore, preferably no linear progression of the transverse cutting surface is formed in the region of the drill tip. By means of the convex curvature, the near-center region of the main cutting surface, hereinafter also referred to as the central inner region, is, when drilling, therefore arranged ahead of outer cutting surface sections that are farther outward in a radial direction.

In the preferred embodiment, the respective main cutting surface in this central inner region is therefore designed to be continuously, i.e., consistently, curved. In the present context, the term “near-center inner region” is understood to mean a near-center region starting from the axis of rotation, which extends in the radial direction over more than ¼ of the radius, in particular over more than ⅓ of the radius and for example up to half of the radius. The radius of curvature may in this case change. The central inner region correspondingly adjoins another outer region, which correspondingly extends over at least ⅓ of the radius, e.g., over at least half of the radius.

The main cutting surface is preferably only curved in a simple manner in the central inner region and further over its entire length from the cutting corner to the pointed drill tip, i.e., it does not comprise multiple counter-rotating (convex-concave), curved cutting surface sections.

Preferably, in addition to the curved cutting surface section in the central inner region, the main cutting surface still comprises a linear section in the outer region. The entire main cutting surface is preferably formed by the (convexly) curved cutting surface section in the central inner region and a linear cutting surface section in the outer region, which adjoins the curved cutting surface section and extends as far as the cutting corner.

The drill is preferably designed as a monolithic drill. Furthermore, the drill preferably consists of carbide.

In principle, the option also exists of designing the drill as a modular drilling tool comprising a shaft having an exchangeable drill tip portion inserted on the front face. This portion has the specific geometry comprising the main cutting surfaces and the adjoining edge-free surfaces. Preferably, this drill tip portion already comprises flute portions, which then transition into flutes formed in the shaft. Such a drill tip portion is attached to the shaft in a suitable manner. In this context, it is often provided that the drill tip portion be rotated in relation to the shaft about the axis of rotation for insertion.

### BRIEF DESCRIPTION OF THE DRAWINGS

An exemplary embodiment of the invention is explained in greater detail hereinafter with reference to the drawings. These drawings show the following partially simplified illustrations:

FIG. 1 a sectional side view of the drill,

FIG. 2 a top view of a front face at the end of the drill,

FIG. 3 a sectional view through the drill at an axial length of the full bit diameter, and

FIG. 4 a sectional side view of the drill in order to clarify a tip region.

### DETAILED DESCRIPTION

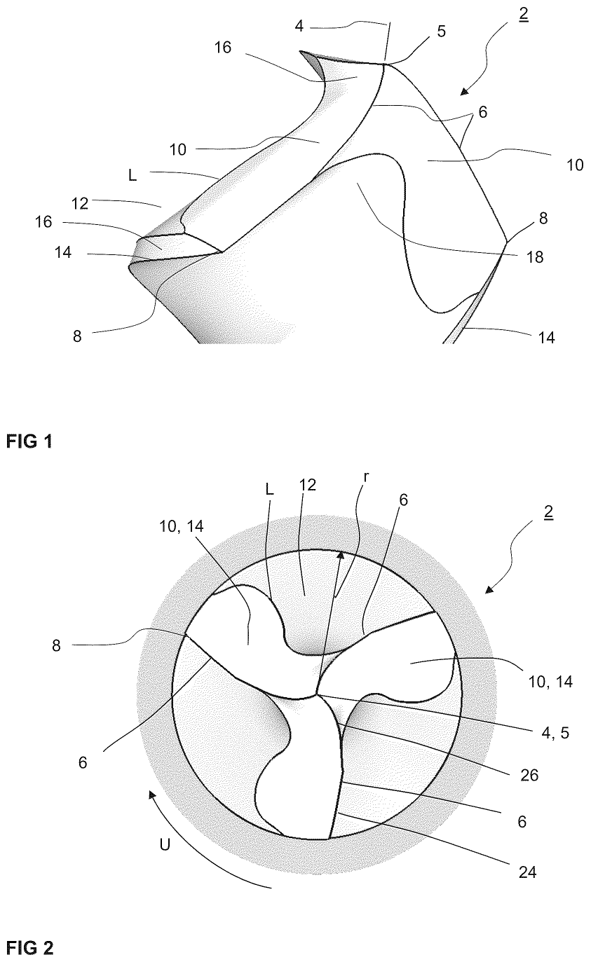

The drill 2, shown in a sectional side view and a front-face overhead view in FIG. 1 and FIG. 2, respectively, is designed as an integral, monolithic drill 2. However, the following statements apply equally to, e.g., modular drills in which a drill tip portion is interchangeably attached to a drill shaft.

The drill 2 generally extends along an axis of rotation 4, about which the drill rotates during operation. The front face at the end of the drill 2 comprises a plurality of, specifically a total of three, main cutting surfaces 6, each extending outwardly from a central, pointed drill tip 5 on the axis of rotation 4 as far as a cutting corner 8.

A radial distance between the axis of rotation 4 and a respective cutting corner 8 defines a radius r.

A respective edge-free surface 10 adjoins each of the main cutting surfaces 6 in a circumferential direction U, specifically starting along the entire length of the main cutting surface 6 and going from the pointed drill tip 5 as far as the cutting corner 8. During its further progression, this edge-free surface 10 transitions into a flute 12 in the circumferential direction U. The edge-free surfaces 10 therefore also define a clearance surface 14. The transition from the edge-free surface 10 and thus the clearance surface 14 into the wall surface of the flute 12 is indicated in FIGS. 1 and 2 by a curved line L, which is designed as an edge, for example, or as a rounded transition. Starting from the cutting corner 8, a respective secondary cutting surface 14 extends along the flute 12, which cutting surface adjoins a secondary cutting surface nose 16 in the circumferential direction U.

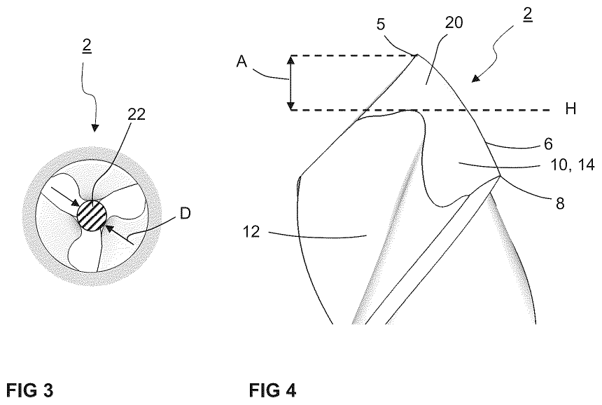

The drill 2 generally comprises a tip region 20, which will be explained in reference to FIG. 3 and FIG. 4. In this context, the longitudinally frontmost region of the drill 2 is understood as extending from the drill tip 5 to a horizontal plane H, which is oriented perpendicular to the axis of rotation 4 and defines the beginning of the flutes 12. The tip region 20 has an axial length A, which is defined by the distance from the drill tip 5 to the horizontal plane H. Starting from the drill tip 5, a full, and thus maximum, bit diameter D is first achieved at the horizontal plane H. The bit diameter D is generally defined as the diameter of a central region of the drill, which is referred to as the drill bit 22 and comprises circular surfaces in the region of the flutes 12. The tip region 20 of this drill bit 22 narrows, so the bit diameter D narrows.

The tip region 20 is therefore generally the frontmost region of the drill, where no flutes 12 are (yet) formed. At least within the tip region 20, all of the front-face surfaces are only designed as edge-free surfaces 10.

As can in particular be gathered from the overhead view according to FIG. 2, a respective main cutting surface 6 in the exemplary embodiment initially extends in a linear manner in an outer region 24, starting from the cutting corner 8, in order to then extend in a curved manner, i.e., convexly curved, in the central inner region 26. In the exemplary embodiment, the transition between the outer region 24, which extends in a linear manner, and the central inner region 26 is approximately half of the radius r.

The main cutting surfaces 6 therefore extend in a curved manner into the pointed drill tip 5, and thus as far as the axis of rotation 4.

Given the front geometry of the drill 2 described herein, and in particular in the tip region 20, it should be emphasized that, on the one hand, the main cutting surfaces 6 extend continuously from the cutting corner 8 to the pointed drill tip 5 located on the axis of rotation 4 and meet in that location. Therefore, no transverse cutting surfaces are formed in the central region of the axis of rotation 4.

It should also be emphasized that the edge-free surfaces 10 directly adjoin the main cutting surfaces 6 over the entire length thereof. In the exemplary embodiment, these edge-free surfaces 10 extend as far as the start of a respective flute 12.

Positionally accurate attachment and drilling are achieved by means of this design. The edge-free surfaces 10 also minimize the wear and stress on the front faces. The drill 2 is in particular a monolithic solid carbide drill. Due to the edge-free design, the risk of local load spikes, which may lead to material degradation, is in particular also minimal.

1. A drill, which extends along an axis of rotation and comprises at least three main cutting surfaces which, starting from a cutting corner arranged on a radius (r), each extend in the direction of the axis of rotation, wherein, starting from a drill tip and over the entire radial extent thereof, the at least three main cutting surfaces converge on the drill tip, and each cutting surface adjoins a respective edge-free surface, which comprises a clearance surface and in each case transitions into a respective flute.

2. The drill according to claim 1, wherein the main cutting surfaces converge on the drill tip without the presence of transverse cutting surfaces.

3. The drill according to claim 1, wherein a tip region of the drill is formed only by the edge-free surfaces, wherein the tip region extends from the drill tip as far as an axial length (A), which corresponds to at least ¼ of the radius (r).

4. The drill according to claim 1, wherein exactly three main cutting surfaces are formed, and the three edge-free surfaces are designed in the manner of tetrahedron surfaces of a degenerated tetrahedron, which is designed to twist within itself about the axis of rotation.

5. The drill according to claim 1, wherein a respective main cutting surface extends in a curved manner into the drill tip.

6. The drill according to claim 1, wherein a central inner region of the respective main cutting surface continuously extends in a curved manner into the drill tip, wherein the central inner region is greater than ¼ of the radius (r).

7. The drill according to claim 5, wherein the respective main cutting surface is curved in only one direction.

8. The drill according to claim 1, wherein the drill is designed as a monolithic drill. in particular made of carbide.

9. The drill according to claim 8, wherein the drill is made of carbide.

10. The drill of claim 3, wherein the top region extends from the drill tip as far as the axial length (A), which corresponds to ⅓ of the radius (r).

11. The drill of claim 3, wherein the top region extends from the drill tip as far as the axial length (A), which corresponds to ½ of the radius (r).

12. The drill of claim 6, wherein the central inner region is greater than ⅓ of the radius (r).

13. A method for manufacturing a drill of claim 1, wherein the edge-free surfaces are introduced in only one grinding step using a grinding method.
